(19) United States
(12) Patent Application Publication
(10) Pub. No.: US 2013/0346254 A1
(43) Pub. Date: Dec. 26, 2013

(54) PROJECT INTERMEDIARY DEVICE AND PROJECT INTERMEDIARY METHOD

(71) Applicant: YAHOO JAPAN CORPORATION, Tokyo (JP)

(72) Inventors: Nobuyuki SHIMIZU, Tokyo (JP); Naoya TAMURA, Tokyo (JP)

(21) Appl. No.: 13/920,404

(22) Filed: Jun. 18, 2013

(30) Foreign Application Priority Data
Jun. 21, 2012 (JP) 2012-139945

(51) Int. Cl. G06Q 30/06

(52) U.S. Cl. CPC G06Q 30/0637
USPC 705/26.82

(57) ABSTRACT

A project intermediary device is connected to a contractee terminal and a contractor terminal in a manner capable of communication. The project intermediary device includes an order information management unit, a product checking unit, and product transmission unit. The order information management unit acquires and manages order information for a project transmitted from the contractee terminal. The product checking unit checks whether or not a product, transmitted from the contractor terminal, for the order information satisfies predetermined criteria. The product transmission unit transmits the product to the contractee terminal when it is determined by the product checking unit that the predetermined criteria are satisfied.

### CROSS-REFERENCE TO RELATED APPLICATIONS

The present application claims priority to and incorporates by reference the entire contents of Japanese Patent Application No. 2012-139945 filed in Japan on Jun. 21, 2012.

### BACKGROUND OF THE INVENTION

1. Field of the Invention

The present invention relates to a project intermediary device and a project intermediary method.

2. Description of the Related Art

In recent years, as one made of outsourcing, crowd-sourcing where a project is outsourced to unspecified number of people is known.

With a service that uses the crowd-sourcing, normally, a contractee who expects a certain level of quality determines whether or not delivery of a product is allowed (a rejection function) so that the quality of a product is guaranteed.

Furthermore, it is also aimed to guarantee the quality of a product by having contractors present proposals regarding a job in response to a job offer from a contractee and the contractee select the most desirable proposal by a so-called competition method (for example, see Japanese Laid-open Patent Publication No. 2010-92451).

However, the service mentioned above that allows a contractee to determine whether or not delivery of a product is allowed may harm the interest (receipt of payment for a product) of a contractor in the case the determination of the contractee is arbitrary. Also, according to the patent document mentioned above, a contractee finalizes the order after receiving a proposal from a contractor, and the interest of the contractor is protected, but in the case the amount of jobs to be offered is large, the burden on the contractee will be great, and thus, this is not realistic. Also, the contractor has to make a proposal regarding the job before formally receiving the order, and the burden is not small.

### SUMMARY OF THE INVENTION

According to one aspect of an embodiment of the present invention, a project intermediary device is connected to a contractee terminal and a contractor terminal in a manner capable of communication. The project intermediary device includes an order information management unit, a product checking unit, and product transmission unit. The order information management unit acquires and manages order information for a project transmitted from the contractee terminal. The product checking unit checks whether or not a product, transmitted from the contractor terminal, for the order information satisfies predetermined criteria. The product transmission unit transmits the product to the contractee terminal when it is determined by the product checking unit that the predetermined criteria are satisfied.

According to another aspect of an embodiment of the present invention, a project intermediary method is performed by a project intermediary device which is connected to a contractee terminal and a contractor terminal in a manner capable of communication. The project intermediary method includes: acquiring and managing, by the project intermediary device, order information for a project transmitted from the contractee terminal; checking, by the project intermediary device, whether or not a product, transmitted from the contractor terminal, for the order information satisfies predetermined criteria; and transmitting, by the project intermediary device, the product to the contractee terminal when it is determined in the checking that the predetermined criteria are satisfied.

According to still another aspect of an embodiment of the present invention, a non-transitory computer-readable storage medium with an executable program stored thereon, wherein the program instructs a computer to perform the following: acquiring and managing order information for a project transmitted from the contractee terminal; checking whether or not a product, transmitted from the contractor terminal, for the order information satisfies predetermined criteria; and transmitting the product to the contractee terminal when it is determined in the checking that the predetermined criteria are satisfied.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration of a crowd-sourcing service system according to an embodiment of the present invention;

FIG. 2 is a diagram illustrating an example of a Web page including a task according to the embodiment;

FIG. 3 is a diagram illustrating an example of a Web page including a task according to the embodiment;

FIG. 4 is a diagram illustrating an example of a Web page including a task according to the embodiment;

FIG. 5 is a diagram illustrating an example of a Web page including a task according to the embodiment; and

FIG. 6 is a flow chart illustrating a task intermediary process according to the embodiment.

### DETAILED DESCRIPTION OF THE PREFERRED EMBODIMENTS

Hereinafter, an embodiment of the present invention will be described based on the drawings.

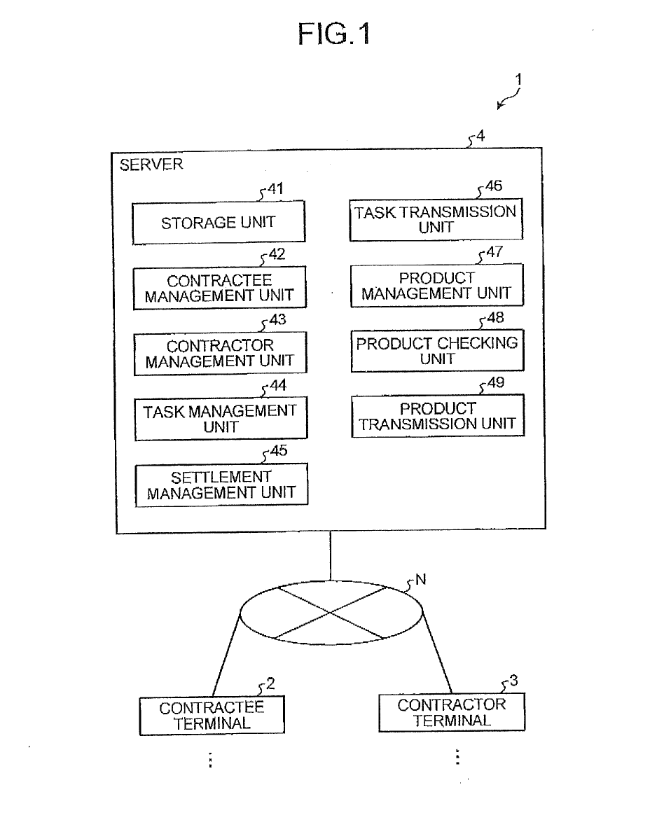

FIG. 1 is a diagram illustrating a configuration of a crowd-sourcing service system 1, which is a project intermediary system according to the present embodiment.

As illustrated in FIG. 1, the crowd-sourcing service system (hereinafter, sometimes abbreviated as a CSS system) 1 according to the present embodiment includes at least one contractee terminal 2 to be operated by a contractee (a requester), at least one contractor terminal 3 to be operated by a contractor (a worker), and a server 4, which is a project intermediary device connected to the contractee terminal 2 and the contractor terminal 3 in a manner capable of two-way communication. The contractee terminal 2, the contractor terminal 3, and the server 4 are configured so as to be able to transmit and receive information over a network N such as the Internet.

According to the CSS system 1, a contractee may order (register) a task to the server 4 by operating the contractee terminal 2. That is, the server 4 acquires and manages a task (order information for a project) transmitted from the contractee terminal 2.

A contractor registered with the server 4 in advance may receive an order for any task among tasks registered with the server 4, by operating the contractor terminal 3.

The server 4 performs a registration process for the task, and also, transmits the task to the contractor terminal 3 of the contractor. Then, the server 4 receives a product from the contractor terminal 3 which has received the order for the task, and delivers the product to the contractee terminal 2, and also, performs a settlement process for paying the compensation to the contractor as necessary. The server 4 may rank the contractor based on a check result of the product, and impose a restriction regarding the unit price for the contractor or regarding the task whose order the contractor is allowed to receive.

A task is a job with respect to which a product may be transmitted/received over a network; for example, the tasks are checking of contents of postings on a homepage or a blog, extraction of information from a homepage, translation of English sentences or the like, spelling check for English sentences or the like, classification of images, transcription from audio data, program creation, and the like.

### Configuration of Contractee Terminal

The contractee terminal 2 is configured from a PC (Personal Computer) that can access the server 4 over the network N, for example. A contractee operates the contractee terminal 2 to perform a registration process for a task on the server 4. Moreover, the contractee receives a product for the task from the server 4 via the contractee terminal 2.

Registration of a task may be performed by an input operation on a Web page provided by the server 4. For example, the contractee can register a task with the server 4 by logging on the server 4 and then inputting the type of a task and content of the task on the Web page. At the time of task registration, a user registers payment information for paying the processing cost for the task with the server 4. This processing cost includes compensation (reward) for the product for a task, and commission for intermediation at the server 4.

Configuration of Contractor Terminal

The contractor terminal 3 is, like the contractee terminal 2, configured from a terminal device that can access the server 4 over the network N. The terminal device can be a PC and a smartphone (a multifunctional mobile phone), for example.

By operating the contractor terminal 3, a contractor may view a Web page or the like provided by the server 4, and receive an order for a task registered by the contractee. The contractor has to be registered in advance with the server 4 as a contractor before receiving an order for the task. The contractor registers, with the server 4, identification information indicating the contractor, and payment information for receiving compensation mentioned above. The payment information is transfer information (bank account number or the like) in the case the contractor prefers cash transfer, and is a user ID or the like of the contractor in the case the contractor prefers online points that can be used in online shopping or the like.

### Configuration of Server

The server 4 is a project intermediary device for intermediating between the contractee terminal 2 and the contractor terminal 3 with respect to tasks. That is, the server 4 provides (transmits) a task registered (transmitted) by the contractee terminal 2 to the contractor terminal 3. Also, the server 4 receives a product for the task from the contractor terminal 3, and transmits the product to the contractee terminal 2. Then, the server 4 obtains the processing cost for the task from the contractee, and gives the reward for the product to the contractor.

The server 4 is configured from a computer on the network N, and includes a CPU (Central Processing Unit) and the like. As illustrated in FIG. 1, the server 4 includes a storage unit 41 configured from a HDD (Hard Disk Drive) or the like, and a contractee management unit 42, a contractor management unit 43, a task management unit (an order information management unit) 44, a settlement management unit 45, a task transmission unit (an order information transmission unit) 46, a product management unit 47, a product checking unit 48, and a product transmission unit 49 that are realized by the CPU executing programs stored in the storage unit 41.

The storage unit 41 stores various programs and data necessary for the operation of the server 4. For example, the storage unit 41 stores an OS (Operating System) and a task management program for performing a task management process described later.

Also, the storage unit 41 stores a contractee database in which information about a contractee is registered, a contractor database in which information about a contractor is registered, a task database in which information about a task ordered is registered, a product database in which a product for a task is registered, and the like. Moreover, the storage unit 41 stores a dummy question in accordance with the type of a task ordered (the project field), and the correct answer for the dummy question.

The contractee management unit 42 acquires information about a contractee from the contractee terminal 2, and manages the same using a contractee database as illustrated in Table 1. Specifically, the contractee management unit 42 registers, in the contractee database, various types of information such as a contractee ID and a contractee name (name of an individual, name of a party, name of a company) which are contractee identification information for identifying a contractee, contractee terminal identification information (IP address or the like) for identifying the contractee terminal 2, and payment information (bank account number or the like) for paying the commission. As will be described later, in the present embodiment, when registering a task, the processing cost is paid in advance, and accordingly, the account number or the like is registered in advance as payment information, and the server 4 is enabled to receive payment by bank withdrawal or the like.

TABLE 1
Contractee Database

| | | Contractee Terminal | |
|---|---|---|---|
| Contractee | Contractee | Identification | Payment |
| ID | Name | Information | Information |
| 1285 | ∘∘ | 124.83. xxxXXX.xxx | |
| 2584 | ΔΔ | | |

The contractor management unit 43 acquires information about a contractor from the contractor terminal 3, and manages the same using a contractor database as illustrated in Table 2. Specifically, the contractor management unit 43 registers, in the contractor database, various types of information such as a contractor ID and a contractor name which are contractor identification information for identifying a contractor, contractor terminal identification information (IP address or the like) for identifying the contractor terminal 3, payment information for receiving the compensation mentioned above, the project field or rank indicating the capacity of the contractor, and the like.

TABLE 2
Contractee Database

| | | Contractee | | | |
|---|---|---|---|---|---|
| Con- | Con- | Terminal | | | |
| tractee | tractee | Identification | Payment | Project | |
| ID | Name | Information | Information | field | Rank |
| 158435 | ** | ***.***.***.*** | | Translation | 5 |
| 254463 | □□ | ***.***.***.*** | | Program | 3 |
| 354528 | ⋄⋄ | ***.***.***.*** | | Translation | 2 |

The task management unit 44 manages the task using a task database as illustrated in Table 3. For example, the task management unit 44 registers, in the task database, various types of information such as identification information separately given to a task ordered (task number or the like), identification information of the contractee who has ordered the task (contractee ID), the type of the task (the project field), the content of the task, the level of difficulty of the task, the compensation for the task (the reward to be paid to the contractor), and the like. Furthermore, the task database includes, in addition to the categories above, a category where delivery information is registered. The delivery info notion indicates whether or not the product for the task has been delivered to the contractee terminal 2. Further, the task database includes a category where information indicating the product is registered. The information indicating the product may be the product itself, or the identification information of the product (product ID) to be registered in the product database described later.

TABLE 3
Task Database

| Task | Contractee | Project | Task | Level of | | Delivery | Product | Related |
|---|---|---|---|---|---|---|---|---|
| No. | ID | field | Content | Difficulty | Compensation | Information | ID | Task |
| T3257 | 1285 | Translation | **** | 2 | 100 | Delivered | S13257 | T4425 |

Moreover, depending on the type of the task for which a product is received, the task management unit 44 creates a new task for checking the product. The new task for checking the product will be described later, but to relate the new task to the original task, a category is provided in the task database under which identification information of a related task is to be registered. In the case the new task is created, the task management unit 44 registers identification information (task number) of the new task under the category of related task information in the record of the original task.

The settlement management unit 45 performs a settlement process accompanying placement and reception of an order for a task. For example, when a task is ordered, the settlement management unit 45 performs a process of receiving the processing cost (reward+commission) for the task in advance from the contractee. In the case the order for the task is not received, the settlement management unit 45 performs a process of refunding the processing cost to the contractee. On the other hand, in the case the order for the task is received, a product transmitted from the contractor terminal 3 is checked, the product which has passed the check is delivered to the contractee terminal 2, and the settlement management unit 45 performs a process of paying the reward to the contractor who has transmitted the product.

In the case an order reception request for a task registered with the server 4 is received from the contractor terminal 3, the task transmission unit 46 transmits information about the task to the contractor terminal 3. At this time, the task transmission unit 46 determines whether or not the contractor is allowed to receive the order for the task.

Specifically, the task transmission unit 46 refers to the task database, and acquires the level of difficulty of the corresponding task. Also, the task transmission unit 46 acquires, from the contractor database, the rank of the contractor operating the contractor terminal 3, based on the contractor ID mentioned above. Then, the task transmission unit 46 determines whether or not the contractor is allowed to receive the order for the corresponding task, based on the level of difficulty and the rank which have been acquired. Then, in the case it is determined that reception of the order is allowed, the task transmission unit 46 transmits a Web page including the content of the task to the contractor, and also, in the case it is determined that reception of the order is not allowed, the task transmission unit 46 transmits a Web page indicating that reception of the order is not possible.

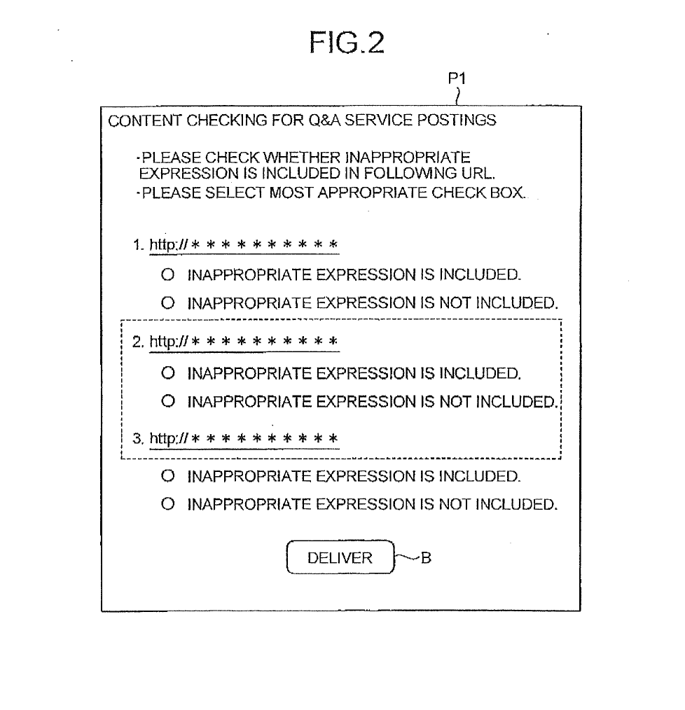

FIGS. 2 to 5 are diagrams each illustrating an example of a Web page including a task. Additionally, a button B indicating “Deliver” in each drawing is a button for performing a process of transmitting a product from the contractor terminal 3 to the server 4.

The task transmission unit 46 transmits Web pages as illustrated in FIGS. 2 to 5 as a Web page including the content of a task ordered.

For example, in the case the type of a task is “checking of content of postings”, and one answer is to be selected, the task transmission unit 46 creates page P1 as illustrated in FIG. 2, and transmits the same to the contractor terminal 3. The type of a task illustrated in FIG. 2, i.e., a task where the contractor selects one answer for a question from a plurality of answers may also be referred herein as “answer selecting project”. In FIG. 2, the page P1 includes, in addition to questions 1 and 3 which are tasks ordered by a contractee, question 2 (question 2 in a region indicated by a dotted line in FIG. 2) which is a dummy question that the task transmission unit 46 has added. This dummy question is stored in the storage unit 41 in advance in accordance with the type of a task, and is acquired from the storage unit 41 by the task transmission unit 46 according to the type of the corresponding task, and is set in page P1 to be transmitted. Additionally, the reason why the dummy question is included in page P1 will be described later in detail.

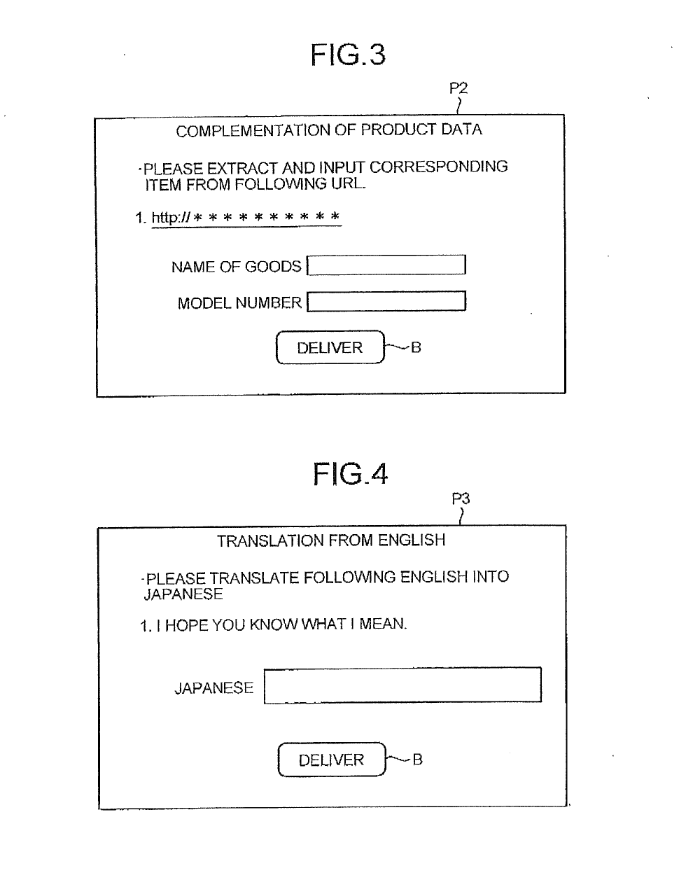

In the case the type of a task is “complementation of product data”, and text such as the name of goods, model number or the like is to be input, the task transmission unit 46 creates page P2 as illustrated in FIG. 3, and transmits the same to the contractor terminal 3.

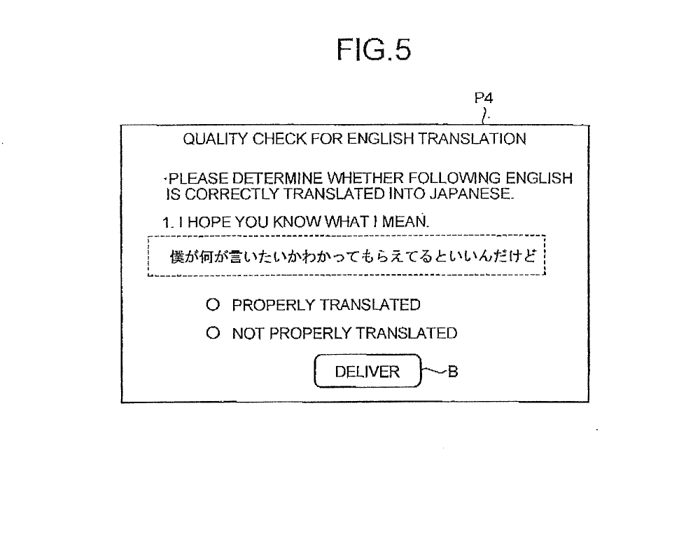

Furthermore, in the case the type of a task is “translation from English”, and a translation is to be input, the task transmission unit 46 creates page P3 as illustrated in FIG. 4, and transmits the same to the contractor terminal 3. Additionally, in the case of a task of this type, it is difficult to automatically determine whether or not the content of the product (that is, the translation) is correct. Accordingly, in the case of a task of this type, a new task (a quality check project) for checking the product (the translation) is created by the task management unit 44. Then, the task transmission unit 46 creates, as a Web page including the content of the task, page P4 as illustrated in FIG. 5 including the English sentence which is the question in FIG. 4, and a translation (the Japanese sentence in a region indicated by a dotted line in FIG. 5) which is the product by the contractor who has received the order for the task illustrated in FIG. 4.

The type of tasks as illustrated in FIG. 3 and FIG. 4 where the contactor inputs a text such as a Japanese translation of an English text may also be referred herein as “text input project”. There are two types of text input projects: one in which the product is the same regardless of the contractor who receives the order and transmits the product; another in which the product can vary according to the contractor who receives the order and transmits the product. For example, “complementation of product data” as illustrated in FIG. 3 is the former, and “translation from English” as illustrated in FIG. 4 is the latter.

The product management unit 47 receives a product for a task from the contractor terminal 3 of a contractor who has received the order for the task. Then, the product management unit 47 registers the received product in a product database as illustrated in Table 4 together with the identification information of the task. As the categories to be included in the product database, there may be cited identification information given to each product (product ID or the like), a target task number of the product, identification information of the contractor (contractor ID) who has transmitted the product, the product which has been received, a check result for the product by the product checking unit 48, and the like. Additionally, in the case the dummy question mentioned above is included in the product registered in the product database, the product from which the answer to the dummy question is removed is registered.

TABLE 4
Product Database

| Product | Task | Contractor | | Check |
|---|---|---|---|---|
| ID | Number | ID | Product | Result |
| S13257 | T3257 | 158435 | **** | Pass |

The product checking unit 48 checks a product received from the contractor terminal 3, and registers the check result in the product database for each product, and determines whether or not the product satisfies predetermined criteria, that is, whether or not the product can be delivered to the contractee terminal 2, that is, whether or not a delivery process is allowed.

For example, with respect to the task illustrated in FIG. 2, that is, a task of answering multiple-choice questions including a dummy question, if the answer to the dummy question is wrong, the product checking unit 48 determines that predetermined criteria are not satisfied and does not allow the delivery process, and if the answer to the dummy question is correct, the product checking unit 48 determines that predetermined criteria are satisfied and allows the delivery process.

Now, the reason why a dummy question is added to a task of answering multiple-choice questions is as follows.

Although there are contractors who work on a task with great care, there are also contractors who work on a task very carelessly. If there are many of the former contractors, the quality is high for the task, but if there are many of the latter contractors, the quality is reduced. Thus, to enhance the quality of products, a measure has to be taken to eliminate the latter contractors.

Therefore, a measure is taken such that a contractor who has transmitted a product where the answer to a question provided as the dummy question is wrong is ranked lower such that tasks whose orders can be received are restricted, or is prevented from successively receiving orders for tasks. Also, the corresponding product is not transmitted to the server, and compensation is not received. That is, it is considered that the contractor did not perform the task whose order has been received. In this manner, by providing a dummy question in a page including content of a task, competent contractors can be extracted, and also, the quality of products can be enhanced.

Additionally, a dummy question whose answer was wrong may be presented to the contractor to point out that the answer was wrong. This way, the contractor can understand the reason why delivery is not allowed. Also, at this time, a contractor who has recognized that the determination by the product checking unit 48 is wrong may be allowed to perform a process of protesting to the determination by entering the reason. The dissatisfaction of the contractor can thereby be grasped, and also, whether or not the qualification by the product checking unit 48 is reasonable may be checked.

Moreover, in the case the answer to a dummy question is wrong, reception of orders for other tasks may be denied for a predetermined period of time. This will cause contractors to be more careful in working on tasks, and as a result, the quality of products may be enhanced.

Furthermore, with respect to the task illustrated in FIG. 3, that is, a task where a contractor has to input a character string such as the name of goods, the model number or the like, and where a product which is a specific character string may be acquired, the product checking unit 48 determines whether or not a product satisfies predetermined criteria, that is, whether or not a product can be delivered, based on the number of matching pieces (the matching rate) among products from a plurality of contractors. Then, the product checking unit 48 takes a product for which the number of matching pieces (the matching rate) is a predetermined value or higher as a product that satisfies predetermined criteria and that can be delivered to the contractee.

For example, in the case “3” is set as the number of matching pieces, the product checking unit 48 determines that predetermined criteria are satisfied (delivery is allowed) when the products from three or more contractors match one another. Also, in the case 75% is set as the matching rate, the product checking unit 48 determines that predetermined criteria are satisfied (delivery is allowed) when three or more products, among products from tour people, match one another, because ¾ is 75%, for example.

Additionally, depending on the content of a task, there may be cases where answers (products) do not easily match one another, such as a case of inputting sentences, for example. In such a case, the likeliness of passing the check, that is, the likeliness of being delivered, may be controlled by changing the number of repetitions (the number of trials and errors necessary for matching of products). For example, in the case a job of inputting “James” in Japanese is requested, there are possibly several answers such as “ [symbol] ”, “ [symbol] ”, “ [symbol] ”, and “ [symbol] ”. In the case only one answer is accepted from a contractor, if spelling is different from the answer of another contractor, the answers are determined to not match.

Thus, if a contractor is allowed to answer a plurality of times, or to input a plurality of answers at one time, and a rule that it is sufficient if one of a plurality of answers matches the answer of another contractor is set, the level of difficulty regarding matching is reduced, and satisfaction of predetermined criteria is more easily determined, and delivery is made easier.

Furthermore, with respect to the task illustrated in FIG. 4, that is, a task where a contractor has to input a character string such as a translation, and where a plurality of answers may be obtained (a primary task), the product checking unit 48 determines whether or not a product illustrated in FIG. 4 satisfies predetermined criteria (whether it can be delivered), based on the product for the task illustrated in FIG. 5, that is, the new task mentioned above (the quality check project=secondary task) for checking the product for the task illustrated in FIG. 4 based on multiple choice answers. The order for this new task may be received by an unspecified number of contractors, but the contractors of the previous task (the primary task) cannot receive the order for this new task. Also, contractors who can receive the order for the quality check project are preferably limited to contractors of a predetermined rank or higher so that the check quality can be guaranteed.

Then, in the case products where the answer “Properly translated” (i.e. passing determination) is set are acquired as the products for the new task at a matching rate (the number of matching pieces) exceeding a predetermined value, the product checking unit 48 determines that the product which is the evaluation target satisfies predetermined criteria, that is, that the product is a product that can be delivered to the contractee. Additionally, this quality check job may be assigned to contractors of a predetermined rank or higher, or to one contractor set as the evaluator in charge.

The product transmission unit 49 transmits a product which has been determined by the product checking unit 48 as satisfying predetermined criteria (allowed to be delivered) to the contractee terminal 2 which has ordered the task of the product. That is, the product transmission unit 49 acquires the identification information of the contractee associated with the corresponding task from the task database, refers to the contractee database based on the identification information, and specifies the identification information of the contractee terminal 2 (the contractee terminal identification information) which has ordered the task. Then, the product for the corresponding task is transmitted to the contractee terminal 2 based on the contractee terminal identification information. Also, after transmitting the product to the contractee terminal 2, the product transmission unit 49 registers, in the task database, the information to the effect that a product for the corresponding task has been delivered and information indicating the product.

### Task Intermediary Process

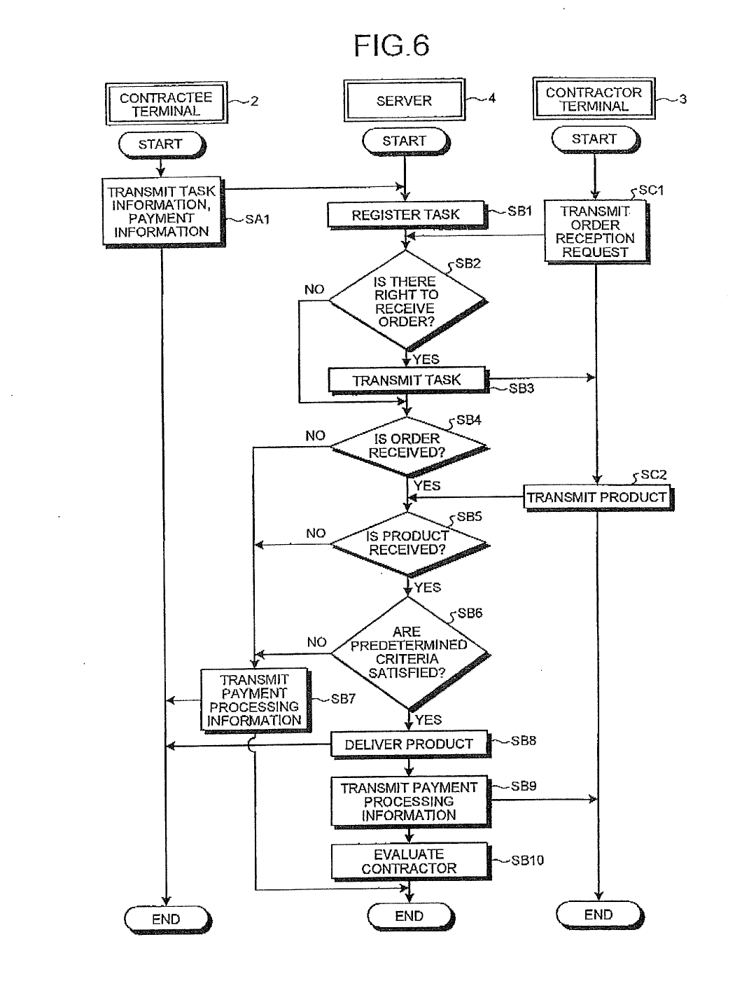

FIG. 6 is a flow chart illustrating a task intermediary process (a project intermediary method) performed by the server 4.

The server 4 performs the following task intermediary process by the configuration described above. Additionally, in the following description, a process for one task is described, but the same can be said for where intermediation is performed for a plurality of tasks.

As illustrated in FIG. 6, with the task intermediary process, first, when information about a task and payment information (compensation) are transmitted from the contractee terminal 2 operated by a contractee registered in advance (step SA1), the task management unit 44 of the server 4 registers the information about the task and the payment information in the task database (step SB1). The information about the task registered in this manner may be viewed by a contractor.

Then, when an order reception request for the task is transmitted from a contractor (step SC1), the task transmission unit 46 of the server 4 determines whether or not this contractor has the right to receive the order for the corresponding task (step SB2).

In the case the server 4 determines in the determination process of step SB2 that the contractor does not have the right to receive the order, the server 4 proceeds with the process to step SB4. That one has the right to receive an order means that conditions set for receiving a task are satisfied in a case conditions that one has to be of a predetermined rank or higher at the time of receiving the order for a task, or that no other task is being received for which the product is not yet delivered are set.

On the other hand, in the case the server 4 determines in the determination process of step SB2 that the contractor has the right to receive the order, the task transmission unit 46 creates a Web page including the content of the corresponding task, and transmits the Web page to the contractor terminal 3 (step SB3). Then, the server 4 proceeds with the process to step SB4.

In step SB4, the task management unit 44 determines whether or not there has been an order reception request within a predetermined period for the task which has been ordered (step SB4).

In the case the server 4 determines in the determination process of step SB4 that there has been no order reception request, the server 4 proceeds with the process to step SB7.

On the other hand, in the case the server 4 determines in the determination process of step SB4 that there has been an order reception request, the product management unit 47 determines whether or not the product for the corresponding task has been received from the contractor terminal 3 within a predetermined period (step SB5).

In the case the server 4 determines in the determination process of step SB5 that the product is not received, the server 4 proceeds with the process to step SB7.

On the other hand, in the case product information including the product is transmitted from the contractor terminal 3 (step SC2), and the server 4 determines in the determination process of step SB5 that the product is received, the product management unit 47 registers the information about the product in the product database, and the product checking unit 48 determines, as described above, whether or not the received product satisfies predetermined criteria, that is, whether or not delivery is allowed (step SB6).

In the case the server 4 determines in the determination process of step SB6 that the product does not satisfy predetermined criteria (that delivery is not allowed), the server 4 proceeds with the process to step SB7. Also, in the case the server 4 determines in the determination process of step SB6 that the product satisfies predetermined criteria (that delivery is allowed), the server 4 proceeds with the process to step SB8.

In step SB7, delivery of the product by the product transmission unit 49 to the contractee terminal 2 is not allowed. Accordingly, in step SB7, the settlement management unit 45 performs a payment process (a refunding process) of processing cost received at the time of registration of the task, and transmits, to the contractee terminal 2, the result of the payment process and the payment processing information indicating the reason for the refunding of the processing cost (step SB7). In the case step SB7 is performed, the task intermediary process ends by the performance of step SB7.

In step SB8, since delivery of the product is allowed, the product transmission unit 49 delivers (transmits) the product to the contractee terminal 2 of the contractee who has ordered the corresponding task (step SB8).

Then, the settlement management unit 45 performs a payment process for the compensation for the contractor who has transmitted the product that was allowed to be delivered with respect to the corresponding task, and transmits payment processing information indicating the result of the payment process to the contractor terminal 3 of the contractor (step SB9).

Furthermore, the contractor management unit 43 performs evaluation of each contractor based on the check result of the product, and changes the rank of the corresponding contractor as necessary (step SB10). For example, the contractor management unit 43 performs a process of lowering the rank of a contractor who has transmitted a product with a wrong answer to the dummy question described above, or the like.

The task intermediary process is thus ended. Additionally, the order of steps SB8 to SB10 may be changed. For example, in the case the product is determined in the determination process of step SB6 to satisfy predetermined criteria, the transmission process for the payment processing information may be performed first, and then, the delivery process for the product may be performed. That is, the determination process of step SB6 may be made the condition for allowing the payment process for the contractor, and the delivery process for the product may be performed with the performance of the payment process as the condition.

According to the crowd-sourcing service system 1 of the present embodiment described above, the following effects may be achieved.

Since the product for a task is checked by the product checking unit 48 of the server 4, which is a project intermediary device, and the product is delivered (transmitted) to the contractee terminal 2 only in the case of passing the check (in the case of satisfying predetermined criteria), the contractee may obtain a product of a certain quality or higher. The contractee itself does not have to perform the quality check and determine whether or not delivery is allowed, and the burden on the contractee may be reduced.

Also, if a product passes the check by the product checking unit 48, the contractor can deliver the product, and thus, delivery is not denied by the arbitrary determination by the contractee. Accordingly, the compensation may be secured as long as a contractor creates a product of an appropriate quality. Moreover, a contractor does not have to perform advance work of making a proposal to receive an order, and the burden regarding the process of receiving an order may be reduced.

The product checking unit 48 selects a checking method of the product according to the content of the task, that is, the project field. The product checking unit 48 selects a correct answer check using a dummy question as illustrated in FIG. 2, a matching check for products (answers) from a plurality of contractors as illustrated in FIG. 3, or a double check using a quality check project by creating a new task as illustrated in FIGS. 4 and 5. Accordingly, a product may be checked according to a checking method appropriate for the content of the task, and the quality of a product to be delivered may be enhanced.

In the case of selection of a multiple-choice answer as illustrated in FIG. 2, the product checking unit 48 transmits a dummy question for which a correct answer is set in advance to the contractor terminal 3, and allows the delivery process described above if the answer returned from the contractor terminal 3 matches the correct answer. If such a dummy question is present in a mixed manner and the quality check is performed based on its result, the product checking unit 48 has only to check whether or not the answer for the dummy question is correct, and the checking process may be easily performed.

Moreover, by setting the level of difficulty or the content of the dummy question, the level or the like of a contractor may be determined, and a product may be obtained from a contractor whose level is desirable to the contractee.

In the case of a task as illustrated in FIG. 3, when products (answers) are transmitted from a plurality of contractor terminals 3, the product checking unit 48 compares the products, and allows the delivery process described above in the case the number of matching pieces (the matching rate) among the products is a predetermined value or more. Accordingly, even with a task of inputting text, and not a task of selecting an answer, the quality may be automatically determined based on the number of matching pieces or the matching rate of the products of a plurality of contractors. Therefore, quality check may be automatically performed by the server 4 for a text-input type task regarding which a checker in charge conventionally performed the quality check.

In the case of tasks as illustrated in FIGS. 4 and 5, when a product is transmitted from a contractor, the product checking unit 48 registers, in the task management unit 44, a quality check project for the product as a new task (order information), and allows the delivery process described above in the case the quality check result transmitted from a contractor terminal other than the contractor terminal 3 which has transmitted the product indicates passing determination. Accordingly, the quality may be guaranteed even for a task such as translation whose quality is difficult to automatically check, by having the product produced by a contractor checked by another contractor. Moreover, the server 4 has only to register the quality check job for a product as a new task, and check the answer of the quality check result, based on two alternatives of pass and fail, and thus, the server 4 may automatically set the double check and perform evaluation.

Moreover, the quality check project for a product is registered as a new task immediately after the product is transmitted from the contractor, and thus, another contractor may perform the quality check project immediately after the product is transmitted from the contractor. In this case, the double check may be performed in real-time, and also, delivery may be swiftly made even with the double check.

### MODIFICATION OF EMBODIMENT

The present invention is not limited to the embodiment described above, and modifications, alterations and the like within the scope allowing the object of the present invention to be achieved are included in the present invention.

In the embodiment described above, a measure is taken with respect to a contractor who has transmitted a product with a wrong answer to the dummy question, to lower the rank of the contractor or to prevent the contractor from successively receiving orders for tasks, but the present invention is not limited to be such. For example, because an answer may be wrong due to a mistake in the operation, the measure of penalty may be taken after a wrong answer is given several times for the dummy question.

Furthermore, in the case a quality check job is made a new task, a dummy question for which an answer is set in advance may be mixed to be checked. For example, in the case of a translation task, dummy questions with correct translation results and dummy questions with wrong translation results may be mixed, and delivery of a product of a quality check job may be prevented if the dummy questions are not answered correctly. This way, the quality of a contractor performing the quality check job may be guaranteed.

Furthermore, as a result of performing the quality check job, if the product is determined not to be correct, the product checking unit 48 may create a quality check job for the product again, and have another contractor perform the quality check job. Particularly, if, in the case the determination of the first quality check that the answer is not correct is fed back to the contractor who has produced the product and button input regarding rechecking is input from the contractor, another contractor is made to perform the quality check job, the dissatisfaction of the contractor regarding the check result may be checked. Also, by analyzing a plurality of quality check job results, the quality of check work of each contractor may be analyzed, and be reflected in the rank of the contractor or the like.

In the embodiment described above, a contractor who has received an order for a task transmits the product for the received task to the server 4, and at this time, a time limit may be imposed, at the server 4, between transmission of the task and the reception of the product. In this case, if a product is not received within the time limit, the server 4 may cancel the reception of order for the task by the contractor. This way, in the case of performing determination based on the number of matching pieces (the matching rate) among the products of a plurality of contractors, the risk of a dishonest act where contractors contact each other and transmit a plurality of products with wrong answers to secure the number of matching pieces can be reduced.

Furthermore, by allowing contractors to perform the process in the order of assignment only for the first task, and randomly changing the order of the contractors for the next task, a dishonest act may be prevented while maintaining real-timeness of the matching check for the products of a plurality of contractors.

For example, if the matching rate cannot be calculated until a plurality of contractors have finished the job, the same job has to be assigned to a plurality of contractors at the same time as much as possible or there will be a waiting time for the first contractor until the second contractor has produced an answer and the result regarding the matching rate is obtained.

To reduce the waiting time and maintain the real-timeness, and to evaluate the matching rate and allow one to move to the next job, it is effective to assign the same jobs to a plurality of contractors who have accessed to receive orders in an order (processing in the order of assignment).

However, contractors who are to work at the same time are highly likely to be assigned with the same job. Therefore, there is a problem that the two contractors consult each other and input the same answer, and the matching check is passed because the answers match each other although being wrong.

Thus, the order of assignment of jobs A, B and C may be randomly changed from the original AAABBBCCC to AABABCBCC, for example. In this case, even if contractors access at the same time, they are less likely to be assigned with the same job because the same jobs are not assigned consecutively as in AA, BB or the like.

Also, to maintain the real-timeness, a process may be performed to present a specific number of jobs in advance until the matching rate is obtained.

Furthermore, in the case of performing determination based on the number of matching pieces (the matching rate) among the products of a plurality of contractors, if matching is not achieved over a predetermined successive number of times, the task may be set so as not to be processed for a predetermined period, or the level of difficulty of the task (a threshold for the number of matching pieces or the matching rate) may be adjusted based on the number of times of trial.

For example, in the case a dishonest contractor produces answers automatically by script or the like, it is highly possible that matching is not achieved for a plurality of products over a predetermined successive number of times. In this case, the work of the dishonest contractor may be eliminated by not allowing the order for the task to be received for a while.

Also, if attempts are made several times for the same task without the number of matching pieces exceeding a predetermined value, the threshold may be made higher as the number of times increases so as to eliminate the work of the dishonest contractor.

In the embodiment described above, the quality check job for a product is set when a product is delivered from the contractor terminal 3, but the quality check job may be performed for a product, from the contractor terminal 3, which has passed the correct answer check where a dummy question is mixed, or the matching check according to which check is performed based on the number of matching pieces or the like of the products of a plurality of contractors. This way, the quality of products may be further enhanced.

In the embodiment described above, the dummy question is stored in the storage unit 41 in advance, but the present invention is not limited to be such. For example, a similar task is extracted from tasks for which delivery has been made, and a question included in the task may be made the dummy question.

In the embodiment described above, compensation is paid to a contractor who has transmitted a product that can be delivered, but the compensation is not limited to cash, and points that can be used in predetermined sites and shops may be given instead.

Furthermore, in the embodiment described above, one of the three types of checking methods, i.e. the correct answer check using a dummy question, the matching check based on a plurality of products, and the double check based on performance of a quality check job, is selected according to the project field of a task, but in the case the type of a task for which an order is to be placed or received is already determined, it is possible to set only one or two of the checking methods.

In the embodiment described above, the task transmission unit 46 is provided, and the task transmission unit 46 acquires the order reception request, transmitted from the contractor terminal 3, regarding order information, and transmits the order information to the contractor terminal 3 in response to the order reception request. In contrast, it is also possible not to provide the task transmission unit 46, and to cause the server 4 to release the order information and to allow any contractor to freely acquire the order information and to work on a task.

According to an aspect of an embodiment, the interest of a contractee (quality guarantee for a product) and the interest of a contractor (securing of compensation for a product) is protected in a crowd-sourcing service, and the burden is reduced for both parties.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A project intermediary device to be connected to a contractee terminal and a contractor terminal in a manner capable of communication, the project intermediary device comprising:
an order information management unit that acquires and manages order information for a project transmitted from the contractee terminal;
a product checking unit that checks whether or not a product, transmitted from the contractor terminal, for the order information satisfies predetermined criteria; and
a product transmission unit that transmits the product to the contractee terminal when it is determined by the product checking unit that the predetermined criteria are satisfied.

2. The project intermediary device according to claim 1, further comprising
a contractor management unit that manages information about the contactor terminal and information about a contractor in association with each other,
the contractor management unit ranks the contractor terminal according to a level of the project whose order the contractor terminal is allowed to receive.

3. The project intermediary device according to claim 1, further comprising
a contractor management unit that manages information about the contactor terminal and information about a contractor in association with each other,
the contractor management unit ranks the contractor terminal based on a result of checking by the product checking unit.

4. The project intermediary device according to claim 1, further comprising
a task transmission unit that transmits an order of a project to the contractor terminal in response to a reception request from the contractor terminal,
the task transmission unit transmits an order of a project to the contractor terminal, which sends a reception request for the order of the project in succession, based on a result of checking by the product checking unit.

5. The project intermediary device according to claim 1, further comprising
a task transmission unit that transmits an order of a project to the contractor terminal in response to a reception request from the contractor terminal,
the task transmission unit does not transmit an order of a project to the contractor terminal, which sends a reception request for the order of the project, for a predetermined time period when the product checking unit determines that a predetermined number of products transmitted by the contractor terminal do not satisfy the predetermined criteria consecutively.

6. The project intermediary device according to claim 1, further comprising
a contractor management unit that manages information about the contactor terminal and information about a contractor in association with each other,
the contractor management unit cancels a reception of an order of the project by the contractor terminal when the product is not transmitted by the contractor terminal for a predetermined period of time.

7. The project intermediary device according to claim 1, further comprising
a task transmission unit that transmits an order of the project to the contractor terminal,
wherein, when there are a plurality of contractor terminals that access the project intermediary device to receive an order, the task transmitting unit changes a sequence of orders transmitted to the plurality of contractor terminals randomly, the orders include same orders for a same project.

8. The project intermediary device according to claim 1, wherein the product checking unit transmits a dummy question whose correct answer is set in advance to the contractor terminal to which the order information has been transmitted, and when an answer returned from the contractor terminal matches the correct answer, determines that the predetermined criteria are satisfied.

9. The project intermediary device according to claim 1, wherein when products for the order information are transmitted from a plurality of contractor terminals, the product checking unit compares each of the products, and when the number of matching pieces or a matching rate among the products is a predetermined value or higher, determines that the predetermined criteria are satisfied.

10. The project intermediary device according to claim 1, wherein the product checking unit
registers, in the order information management unit, a quality check project, as new order information, for the product transmitted from the contractor terminal, and
determines that the predetermined criteria are satisfied, when a quality check result transmitted from the contractor terminal other than the contractor terminal which has transmitted the product passes determination.

11. The project intermediary device according to claim 1,
wherein the order information includes a category indicating a project field of the order information,
wherein when the project field is an answer selecting project, the product checking unit transmits a dummy question whose correct answer is set in advance to the contractor terminal to which the order information has been transmitted, and when an answer returned from the contractor terminal matches the correct answer, determines that the predetermined criteria are satisfied, and
wherein when the project field is a text input project, when products for the order information are transmitted from a plurality of contractor terminals, the product checking unit compares each of the products, and when the number of matching pieces or a matching rate among the products is a predetermined value or higher, determines that the predetermined criteria are satisfied.

12. The project intermediary device according to claim 1, wherein the order information includes a type category indicating a project field of the order information,
wherein when the project field is an answer selecting project, the product checking unit transmits a dummy question whose correct answer is set in advance to the contractor terminal to which the order information has been transmitted, and when an answer returned from the contractor terminal matches the correct answer, determines that a primary check is passed,
wherein when the project field is a text input project, when products for the order information are transmitted from a plurality of contractor terminals, the product checking unit compares each of the products, and when the number of matching pieces or a matching rate among the products is a predetermined value or higher, determines that the primary check is passed,
wherein the product checking unit registers, in the order information management unit, a secondary check project, as new order information, for the product which is determined to have passed the primary check, and
wherein the product checking unit determines that the predetermined criteria are satisfied, when a secondary check result transmitted from the contractor terminal other than the contractor terminal which has transmitted the product passes determination.

13. A project intermediary method to be performed by a project intermediary device to be connected to a contractee terminal and a contractor terminal in a manner capable of communication, the project intermediary method comprising:
acquiring and managing, by the project intermediary device, order information for a project transmitted from the contractee terminal;
checking, by the project intermediary device, whether or not a product, transmitted from the contractor terminal, for the order information satisfies predetermined criteria; and
transmitting, by the project intermediary device, the product to the contractee terminal when it is determined in the checking that the predetermined criteria are satisfied.

14. A non-transitory computer-readable storage medium with an executable program stored thereon, wherein the program instructs a computer to perform:
acquiring and managing order information for a project transmitted from a contractee terminal;
checking whether or not a product, transmitted from a contractor terminal, for the order information satisfies predetermined criteria; and
transmitting the product to the contractee terminal when it is determined in the checking that the predetermined criteria are satisfied.
